(19) United States
(12) Patent Application Publication
(10) Pub. No.: US 2020/0133246 A1
(43) Pub. Date: Apr. 30, 2020

(54) LEARNING MODEL GENERATION DEVICE FOR SUPPORTING MACHINE TOOL, SUPPORT DEVICE FOR MACHINE TOOL AND MACHINE TOOL SYSTEM

(71) Applicant: JTEKT Corporation, Osaka-shi (JP)

(72) Inventors: Toru KAWAHARA, Chita-gun (JP); Yuki MASUDA, Nagoya-shi (JP); Shinji MURAKAMI, Toyota-shi (JP)

(73) Assignee: JTEKT Corporation, Osaka-shi (JP)

(21) Appl. No.: 16/669,572

(22) Filed: Oct. 31, 2019

(30) Foreign Application Priority Data
Oct. 31, 2018 (JP) 2018-205594

(51) Int. Cl. G05B 19/418; G06N 20/00; G05B 19/4065

(52) U.S. Cl. CPC G05B 19/41815; G05B 19/4065; G06N 20/00; G05B 19/4185

(57) ABSTRACT

A learning model generation device for supporting a machine tool, includes: a first non-control element acquisition unit configured to acquire a first non-control element, the first non-control element including at least one of specifications of a workpiece and specifications of a tool and being not a machining control element for a machine tool; a machining control element acquisition unit configured to acquire the machining control element for the machine tool; and an actual quality element acquisition unit configured to acquire an actual quality element of the workpiece after machining. The leaning model generation device further includes a learning model generation unit configured to generate, by machine learning in which the first non-control element, the machining control element and the actual quality element are set as learning data, a learning model for outputting the machining control element based on the first non-control element and the actual quality element.

### CROSS-REFERENCES TO RELATED APPLICATIONS

This application is based upon and claims the benefit of priority from Japanese Patent Application No. 2018-205594, filed on Oct. 31, 2018; the entire contents of which are incorporated herein by reference.

### FIELD

One or more embodiments of the present invention relate to a learning model generation device for supporting a machine tool, a support device for a machine tool, and a machine tool system.

### BACKGROUND

A machining condition of a machine tool, in particular, a machining control element of the machine tool, is determined as follows. The machining control element is, for example, rotational speed of a workpiece, feed speed of a tool, or the like. First, specifications of the workpiece such as an original shape of the workpiece, a final shape of the workpiece, and a material of the workpiece are determined. Then, a machining control element is determined to satisfy a target quality element of the workpiece. The target quality element is a surface property such as surface roughness. In addition, the machining control element is determined to fall within target machining time. However, determining the machining control element is not easy and requires skilled knowledge, know-how, and the like.

Here, in general, the expression “machining condition” may be used in the sense of adding a non-control element (such as specifications of a workpiece or specifications of a tool) to the machining control element, in addition to the case where the expression “machining condition” means the machining control element. Therefore, in the present specification, the expressions “machining control element” and “non-control element” are used without using the expression “machining condition”.

In recent years, with an improvement in machining speed of a computer, artificial intelligence has been rapidly developed. For example, JP-A-2017-164801 states that laser machining condition data is generated by machine learning. Specifically, the machine learning device learns a state quantity of a machine tool and a relationship between a machining result and a machining control element (machining condition), and outputs a machining control element (machining condition) using a learning model. For example, the state quantity of the machine tool is light output characteristics of a laser device, which shows a relationship between a light output command for the laser device and a light output actually emitted from the laser device.

### SUMMARY

However, the machine learning device described in JP-A-2017-164801 is required to acquire the state quantity of the machine tool, and it is not easy to acquire the state quantity. That is, the state quantity varies widely and changes depending on a progress of machining, and is very complicated information.

An object of an aspect of the present invention is to provide a learning model generation device for supporting a machine tool capable of generating a leaning model for outputting a machining control element of the machine tool without using a state quantity of a machine tool. An object of another aspect of the present invention is to provide a support device for a machine tool, and a machine tool system, which is capable of outputting a machining control element of a machine tool without using a state quantity of a machine tool.

One or more embodiments of the present invention provide a learning model generation device for supporting a machine tool, including: a first non-control element acquisition unit configured to acquire a first non-control element, the first non-control element including at least one of specifications of a workpiece and specifications of a tool and being not a machining control element for a machine tool; a machining control element acquisition unit configured to acquire the machining control element for the machine tool; an actual quality element acquisition unit configured to acquire an actual quality element of the workpiece after machining; and a learning model generation unit configured to generate, by machine learning in which the first non-control element, the machining control element and the actual quality element are set as learning data, a learning model for outputting the machining control element based on the first non-control element and the actual quality element.

One or more embodiments of the present invention provide a support device for a machine tool, including: the learning model generation device for supporting a machine tool described above; a second non-control element acquisition unit configured to acquire a second non-control element, the second non-control element including at least one of specifications of the workpiece and specifications of the tool and being not a machining control element for a machine tool; a target quality element acquisition unit configured to acquire a target quality element of the workpiece; and an output unit configured to output the machining element corresponding to the second non-control element and the target quality element by using the learning model.

One or more embodiments of the present invention provide a machine tool system including: a plurality of machine tools; a server configured to communicate with the plurality of machine tools; a plurality of edge computers provided in the plurality of machine tools, respectively, and configured to communicate with the server, wherein the server includes the learning model generation device for supporting a machine tool described above, wherein the learning model generation device for supporting a machine tool generates the learning model based on the first non-control element, the machining control element and the actual quality element acquired from each of the plurality of machine tools, wherein each of the plurality of edge computers includes the support device for a machine tool described above, and wherein the learning model generation unit of the learning model generation device for supporting a machine tool stores the generated learning model in the learning model storage unit of the support device for a machine tool.

The learning model is a model that allows the machining control element to be output based on the first non-control element and the actual quality element. Therefore, in order to output the machining control element, it is sufficient to acquire information corresponding to the first non-control element and information corresponding to the actual quality element. Further, it is possible to easily acquire the information corresponding to the first non-control element and the information corresponding to the actual quality element.

According to the support device for a machine tool, the machining control element can be output by acquiring the second non-control element corresponding to the first non-control element and the target quality element corresponding to the actual quality element.

The machine tool system acquires elements (the non-control element, the machining control element, and the actual quality element, described) related to the plurality of machine tools, and generates a learning model by using these elements. Therefore, the learning model is generated in consideration of information related to various machining. Then, the learning model is stored in the edge computer provided in each of the machine tools. Therefore, when the machining control element is to be determined by the edge computer provided in each of the machine tools, the machining in the other machine tool can be taken into account. Accordingly, a more efficient machining control element can be determined.

### BRIEF DESCRIPTION OF DRAWINGS

FIG. 1 is a diagram showing a configuration of a machine tool system.

FIG. 2 is a plan view of a grinding machine as an example of a machine tool.

FIG. 3 is a functional block diagram of a support device in the machine tool system.

FIG. 4 is a diagram showing an example of a display mode in a display unit of the support device.

### DETAILED DESCRIPTION

(1. Configuration of Machine Tool System 1)

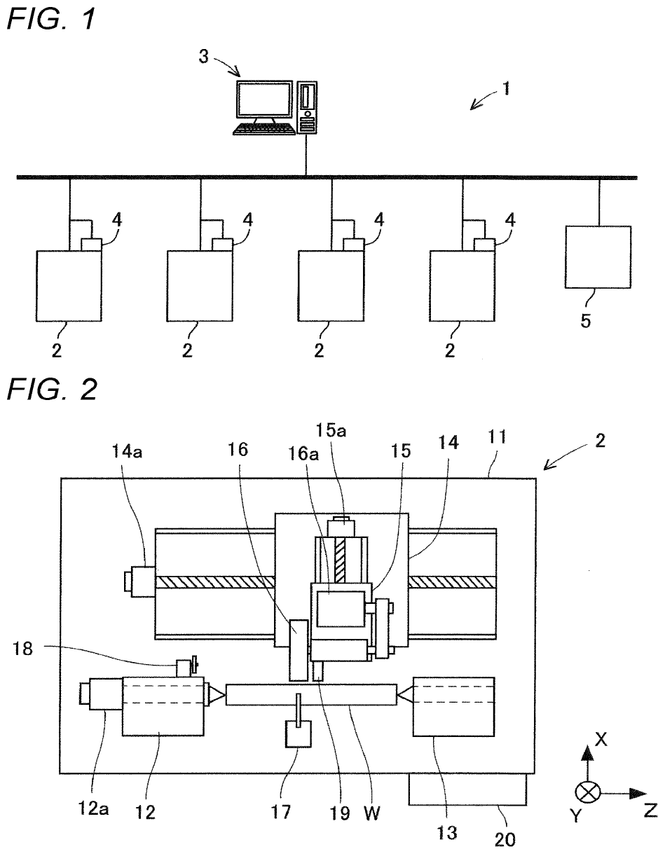

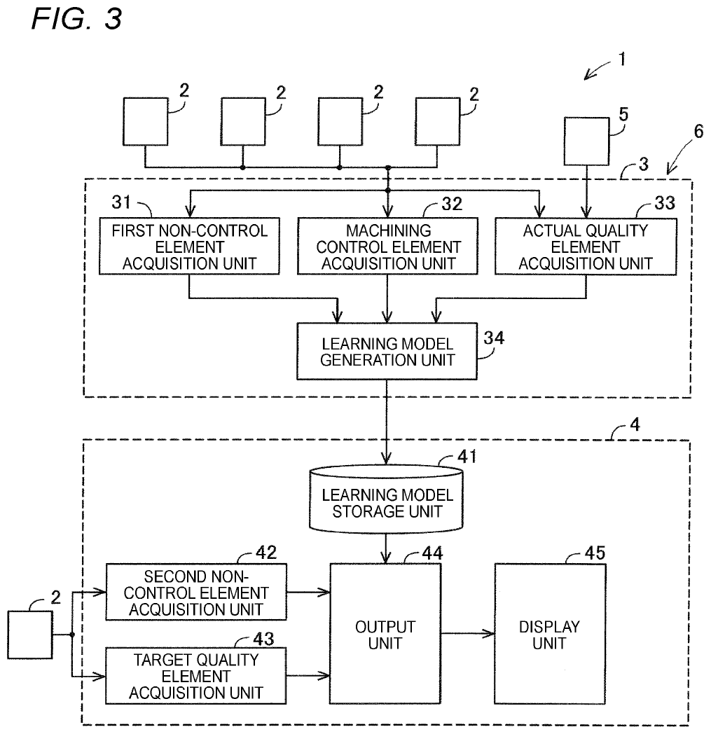

A configuration of a machine tool system 1 will be described with reference to FIG. 1. The machine tool system 1 can support for determining machining control elements in machine tools 2. The machine tool system 1 includes a plurality of machine tools 2, a server 3, a plurality of edge computers 4, and an inspection device 5. Here, the server 3 and the edge computer 4 constitute a support system 6 (shown in FIG. 3) for determining a machining control element.

The machine tool 2 is a machine that performs machining on a workpiece W. The machine tool 2 is, for example, a machine that performs machining such as cutting, grinding, cleaving, forging, and bending. The server 3 communicates with the plurality of machine tools 2. The server 3 collects various information from the plurality of machine tools 2 and performs arithmetic processing based on the collected information. The server 3 has a function of performing machine learning. Then, the server 3 generates a learning model obtained by the machine learning.

Each of the plurality of edge computers 4 is provided in each of the plurality of machine tools 2. The edge computer 4 can output a machining control element using the learning model generated by the server 3. That is, an operator can efficiently obtain a better machining control element by using the edge computer 4 even if the operator does not have skilled knowledge or know-how. The edge computer 4 may be configured as a device separate from the machine tool 2, or may be configured as a device incorporated in the machine tool 2.

The inspection device 5 inspects quality of the workpiece W machined by the plurality of machine tools 2. Quality inspection includes shape inspection, surface roughness inspection, presence/absence of a chatter mark, and the like. The inspection device 5 can also acquire an image of the workpiece W in addition to the measurement. The inspection device 5 can communicate with the server 3, and can transmit an inspection result to the server 3. The inspection device 5 has been described as a device separate from the machine tools 2, and some of functions or all of functions thereof may be incorporated into the machine tools 2.

(2. Configuration of Machine Tool) A configuration of an example of the machine tool 2 will be described with reference to FIG. 2. An example of the machine tool 2 includes a grinding machine. The grinding machine is a machine for grinding the workpiece W. A grinding machine having various configurations, such as a cylindrical grinding machine and a cam grinding machine, can be applied to the machine tool 2. In the present embodiment, the machine tool 2 is exemplified by a grinding head traverse cylindrical grinding machine. However, a table traverse grinding machine may be applied to the machine tool 2.

The machine tool 2 mainly includes a bed 11, a headstock 12, a tailstock 13, and a traverse base 14, a grinding head 15, a grinding wheel 16 (tool), a sizing device 17, a grinding wheel correction device 18, and a coolant device 19, and a control device 20.

The bed 11 is fixed onto an installation surface. The headstock 12 is provided on an upper surface of the bed 11 on a front side in an X-axis direction (lower side in FIG. 2) and on one end side in a Z-axis direction (left side in FIG. 2). The headstock 12 supports the workpiece W such that the workpiece W is rotatable about a Z-axis. The workpiece W is rotated by driving a motor 12a provided on the headstock 12. The tailstock 13 is provided on the upper surface of the bed 11 at a position where the tailstock 13 faces the headstock 12 in the Z-axis direction, that is, on the front side in the X-axis direction (lower side in FIG. 2) and on the other end side in the Z-axis direction (right side in FIG. 2). That is, the headstock 12 and the tailstock 13 support the workpiece W at both ends thereof such that the workpiece W is rotatable.

The traverse base 14 is provided on the upper surface of the bed 11 and is movable in the Z-axis direction. The traverse base 14 is moved by driving a motor 14a provided on the bed 11. The grinding head 15 is provided on an upper surface of the traverse base 14, and is movable in the X-axis direction. The grinding head 15 is moved by driving a motor 15a provided on the traverse base 14.

The grinding wheel 16 is formed into a disk shape and is supported by the grinding head 15 such that the grinding wheel 16 is rotatable. The grinding wheel 16 is rotated by driving a motor 16a provided on the grinding head 15. The grinding wheel 16 is formed by fixing a plurality of abrasive grains with a bonding material. The abrasive grains include general abrasive grains and super-abrasive grains. As the general abrasive grains, a ceramic material such as alumina or silicon carbide is well known. The super-abrasive particles are diamond or CBN.

The sizing device 17 measures a dimension (diameter) of the workpiece W. The grinding wheel correction device 18 corrects a shape of the grinding wheel 16. The grinding wheel correction device 18 is a device that performs truing on the grinding wheel 16. The grinding wheel correction device 18 may be a device that performs dressing on the grinding wheel 16 in addition to truing or instead of truing. The grinding wheel correction device 18 also has a function of measuring a dimension (diameter) of the grinding wheel 16.

Here, truing is a reshaping operation, and is, for example, an operation of molding the grinding wheel 16 to match a shape of the workpiece W when the grinding wheel 16 is worn by grinding, and an operation of removing a shake of the grinding wheel 16 due to an uneven abrasion. The dressing is a dressing operation and is an operation of adjusting protrusion amount of the abrasive grains or creating a cutting edge of the abrasive grains. Dressing is an operation of correcting glazing, shedding, and loading, and is generally performed after truing.

The coolant device 19 supplies coolant to a grinding point of the workpiece W according to the grinding wheel 16. The coolant device 19 cools the recovered coolant to have a predetermined temperature and supplies the coolant to the grinding point again.

The control device 20 controls each drive device based on a NC program. The NC program is generated based on a non-control element such as the shape of the workpiece W and the shape of the grinding wheel 16, and a machining control element such as rotational speed of the workpiece W and feed speed of the grinding wheel 16. The machining control element also includes information of coolant supply timing, timing information for correcting the grinding wheel 16, and the like.

That is, the control device 20 performs grinding of the workpiece W by controlling the motors 12a, 14a, 15a, 16a, and the coolant device 19 based on the generated NC program. In particular, the control device 20 performs grinding, based on the diameter of the workpiece W measured by the sizing device 17, until the workpiece W has a final shape. The control device 20 corrects the grinding wheel 16 (truing and dressing) by controlling the motors 14a, 15a, 16a, and the grinding wheel correction device 18 at the timing of correcting the grinding wheel 16.

(3. Configuration of Support System 6)

A configuration of a support system 6 will be described with reference to FIG. 3. As described above, the support system 6 is a device to determine a machining control element using the learning model. In particular, the support system 6 includes the server 3 (an example of a learning model generation device for supporting a machine tool) and the plurality of edge computers 4 (an example of a support device for a machine tool) in the present embodiment. That is, the support system 6 generates a learning model based on the elements (a non-control element, a machining control element, and an actual quality element, described below) related to the plurality of machine tools 2, and outputs a machining control element in each of the machine tools 2 using the learning model. Each of the server 3 and the edge computers 4 includes a processor and a memory, and the processor executes a computer program stored in the memory. For example, the memory of the server 3 stores a program for executing the functions of the learning model generation device for supporting a machine tool, and the memory of the edge computer 4 stores a program for executing the functions of the support device for a machine tool.

However, the support system 6 may be provided only in one machine tool 2. In this case, the support system 6 generates a learning model based on elements (a non-control element, a machining control element, and an actual quality element, described below) related to one machine tool 2, and outputs a machining control element in the machine tool 2 using the learning model.

In the present embodiment, the support system 6 includes the server 3 and the plurality of edge computers 4. The server 3 performs processing of learning phases of the machine learning, and each of the plurality of edge computers 4 performs processing of inference phases of the machine learning.

The server 3 communicates with each of the plurality of machine tools 2. The server 3 includes a first non-control element acquisition unit 31, a machining control element acquisition unit 32, an actual quality element acquisition unit 33, and a learning model generation unit 34.

The first non-control element acquisition unit 31 acquires, from each of the plurality of machine tools 2, a first non-control element that is not a machining control element for the machine tool 2 among the elements related to machining in each of the plurality of machine tools 2. The first non-control element includes specifications of the workpiece W and specifications of the grinding wheel 16 (tool). Specifications of the workpiece W include the final shape of the workpiece W, an original shape of the workpiece W, and a material of the workpiece W. Specifications of the workpiece W may include machining allowance of the workpiece W instead of the original shape of the workpiece W. It should be noted that the first non-control element may include all of the elements described above, or may be only some of the elements described above. Specifications of the grinding wheel 16 include a material of the grinding wheel 16 and the shape of the grinding wheel 16.

The machining control element acquisition unit 32 acquires, from each of the plurality of machine tools 2, a machining control element for the machine tool 2 among the elements related to machining in each of the plurality of machine tools 2. The machining control element is parameters that can be set by the NC program, that is, parameters that can be adjusted by controlling the drive device. The machining control element includes, for example, rotational speed of the workpiece W, feed speed of the grinding wheel 16 relative to the workpiece W, a switching position of machining steps, and spark-out time. The machining steps include a roughening step, a precise grinding step, a fine grinding step, and a spark-out step. The switching position means a feeding direction position of the grinding wheel 16 at the time of switching the machining steps. It should be noted that the machining control element may include all of the elements described above, or may be only some of the elements described above.

The actual quality element acquisition unit 33 acquires, from the inspection device 5, the actual quality element of the workpiece W after machining, which is detected by the inspection device 5. The workpiece W to be acquired is a workpiece W machined by the plurality of machine tools 2. Therefore, the actual quality element acquisition unit 33 acquires the actual quality element of the workpiece W machined in the plurality of machine tools 2. The actual quality element is, for example, a state of a machining deterioration layer of the workpiece W, a surface property of the workpiece W, and a state of a chatter mark of the workpiece W. That is, the inspection device 5 is a detector for detecting a state of the machining deterioration layer, a detector for detecting a surface property, a detector for detecting a state of a chatter mark, and the like. It should be noted that the actual quality element may include a quality element other than those described above.

Data of the state of the machining deterioration layer may be data indicating presence/absence of the machining deterioration layer, or may be a score related to degree of the machining deterioration layer. Data of the surface property may be a value of surface roughness itself or may be a score related to degree of the surface roughness. Data of the state of the chatter mark may be data indicating presence/absence of a chatter mark or may be a score related to degree of the chatter mark. Each score is represented by, for example, a mark with a plurality of grades.

Further, the actual quality element acquisition unit 33 may acquire data related to machining time in each of the plurality of machine tools 2 as one of the actual quality elements. Data related to the machining time is, for example, data indicating whether actual machining time is long or short relative to reference machining time (corresponding to target machining time) of the workpiece W.

The learning model generation unit 34 performs machine learning in which the first non-control element, the machining control element, and the actual quality element are set as learning data. The learning model generation unit 34 generates a learning model related to the first non-control element, the actual quality element, and the machining control element by the machine learning. In other words, the learning model is used for outputting a machining control element based on the first non-control element and the actual quality element.

Each of the plurality of edge computers 4 is provided in each of the plurality of machine tools 2. The edge computer 4 can communicate with the server 3 and can communicate with the corresponding machine tool 2. The edge computer 4 includes a learning model storage unit 41, a second non-control element acquisition unit 42, a target quality element acquisition unit 43, an output unit 44, and a display unit 45.

The learning model storage unit 41 acquires the learning model generated by the learning model generation unit 34 by transmission of the learning model generation unit 34. Then, the learning model storage unit 41 stores the acquired learning model. Here, the same learning model is stored in the learning model storage unit 41 of each of the edge computers 4.

The second non-control element acquisition unit 42 acquires, by an input from the operator, a second non-control element, which is not a machining control element for the machine tool 2, among the elements related to machining in the corresponding machine tool 2. The operator may input the second non-control element by operating the machine tool 2, or may input the second non-control element by operating the edge computer 4.

The second non-control element is an element corresponding to the first non-control element and is substantially the same as the first non-control element. The second non-control element includes the specifications of the workpiece W and the specifications of the grinding wheel 16 (tool). That is, the second non-control element includes the specifications of the workpiece W to be machined by the operator using the machine tool 2, and the specifications of the grinding wheel 16 attached to the machine tool 2.

The target quality element acquisition unit 43 acquires, by an input from the operator, the target quality element of the workpiece W to be machined by using the corresponding machine tool 2. The operator may input the target quality element by operating the machine tool 2, or may input the target quality element by operating the edge computer 4. The target quality element is an element corresponding to the actual quality element and is substantially the same as the actual quality element. The target quality element is, for example, a target state of a machining deterioration layer, a target surface property, and a target state of a chatter mark. Further, the target quality element may include a target machining time.

The output unit 44 outputs the machining control element by using the learning model stored in the learning model storage unit 41. As described above, the machining control element is parameters that can be adjusted by the NC program, that is, parameters that can be adjusted by controlling the drive device.

Here, as described above, the learning model is related to the first non-control element, the actual quality element, and the machining control element. That is, the learning model can output a machining control element when the first non-control element and the actual quality element are input. Therefore, the output unit 44 receives the second non-control element corresponding to the first non-control element and the target quality element corresponding to the actual quality element. Then, the output unit 44 can output a machining control element corresponding to the input second non-control element and the input target quality element by using the learning model.

Further, the output unit 44 may output only a machining control element with one pattern, or may output machining control elements with a plurality of patterns. For example, the similar quality can be obtained by adjusting the switching position of each machining step (grinding step, precise grinding step, fine grinding step, spark-out step) and the feeding speed of the grinding wheel 16 in each machining step. Therefore, the result obtained by using the learning model is not limited to the machining control element with one pattern, and may be the machining control elements with a plurality of patterns.

When there are machining control elements that satisfy all of the plurality of target quality elements exist with a plurality of patterns, a priority order may exist among the plurality of target quality elements. For example, the target quality elements (corresponding to predetermined conditions set in advance) may be ordered by the priority order as the state of the machining deterioration layer, the state of the chatter mark, and the machining time. In this case, the output unit 44 can output machining control elements with a plurality of patterns and output the order of the plurality of patterns based on the priority order. That is, the output unit 44 can output the order of machining control elements with the plurality of patterns based on the predetermined conditions set in advance.

The display unit 45 displays output information output by the output unit 44. Here, a display device of the edge computer 4 may be applied to the display unit 45, or a display device such as an operation panel of the machine tool 2 may be applied thereto. Here, when the output unit 44 outputs a machining control element with one pattern, the display unit 45 displays the machining control element with a pattern. When the output unit 44 outputs machining control elements with a plurality of patterns, the display unit 45 displays the machining control elements with the plurality of patterns.

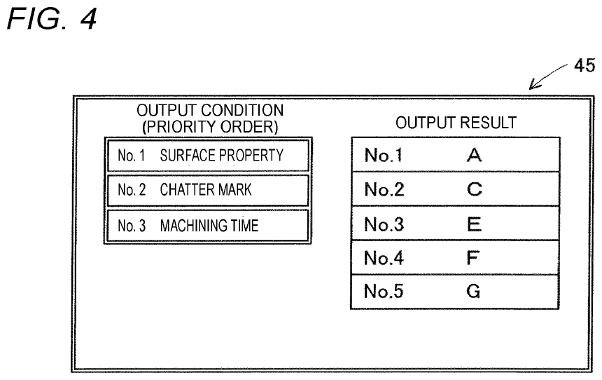

An example of the display unit 45 is shown in FIG. 4. FIG. 4 shows display contents in a case where the output unit 44 outputs the machining control elements with a plurality of patterns and a priority order (predetermined condition) of the target quality elements is set in advance. The target quality elements may be ordered by the priority order as the state of the machining deterioration layer (first), the state of the chatter mark (second), and the machining time (third). In this case, the priority order of the target quality elements is displayed in a left column of the display unit 45.

The output result is displayed in a right column of the display unit 45. The output result in the display unit 45 is displayed in a state where the machining control elements with a plurality of patterns are ranked to correspond to the priority order. Here, all the patterns A, B, C, D, E of the machining control elements satisfy the target quality element in FIG. 4. Among these, the pattern A is the best machining control element in the case of ranking based on the predetermined conditions.

(4. Effect)

When the learning model is generated in advance, the operator can easily acquire the machining control element by inputting the specifications of the workpiece W as the second non-control element, the specifications of the grinding wheel 16 (tool), and the target quality element. Therefore, even if the operator does not have skilled knowledge or know-how, a more appropriate machining control element can be obtained. As a result, the operator can easily acquire the setting parameters in the NC program, and can easily create the NC program.

Here, the learning model is a model that allows the machining control element to be output based on the first non-control element and the actual quality element. Therefore, in order to output the machining control element, information corresponding to the first non-control element and information corresponding to the actual quality element may be acquired. It is possible to easily acquire the second non-control element that is information corresponding to the first non-control element and the target quality element that is information corresponding to the actual quality element. Then, the machining control element can be output by acquiring the second non-control element corresponding to the first non-control element and the target quality element corresponding to the actual quality element in advance.

Further, the machine tool system 1 acquires elements (the non-control element, the machining control element, and the actual quality element, described) related to the plurality of machine tools 2, and generates a learning model by using these elements. Therefore, the learning model is generated in consideration of information related to various machining. Then, the learning model is stored in the edge computer 4 provided in each of the machine tools 2. Therefore, when the machining control element is to be determined by the edge computer 4 provided in each of the machine tools 2, the machining in the other machine tool 2 can be taken into account. Accordingly, a more efficient machining control element can be determined.

1. A learning model generation device for supporting a machine tool, comprising:
a first non-control element acquisition unit configured to acquire a first non-control element, the first non-control element including at least one of specifications of a workpiece and specifications of a tool and being not a machining control element for a machine tool;
a machining control element acquisition unit configured to acquire the machining control element for the machine tool;
an actual quality element acquisition unit configured to acquire an actual quality element of the workpiece after machining; and
a learning model generation unit configured to generate, by machine learning in which the first non-control element, the machining control element and the actual quality element are set as learning data, a learning model for outputting the machining control element based on the first non-control element and the actual quality element.

2. The learning model generation device for supporting a machine tool according to claim 1,
wherein the tool comprises a grinding wheel configured to grind the workpiece, and
wherein the machining control element comprises at least one of rotational speed of the workpiece, feed speed of the grinding wheel relative to the workpiece, a switching position of machining steps, and spark-out time.

3. The learning model generation device for supporting a machine tool according to claim 1,
wherein the specifications of the workpiece comprise at least one of a final shape of the workpiece, an original shape of the workpiece, and a material of the workpiece, and
wherein the specifications of the tool comprise at least one of a material of the tool and a shape of the tool.

4. The learning model generation device for supporting a machine tool according to claim 1, wherein the actual quality element is at least one of a state of a machining deterioration layer of the workpiece, a surface property of the workpiece, and a state of a chatter mark of the workpiece.

5. A support device for a machine tool, comprising:
the learning model generation device for supporting a machine tool according to claim 1;
a second non-control element acquisition unit configured to acquire a second non-control element, the second non-control element including at least one of specifications of the workpiece and specifications of the tool and being not a machining control element for a machine tool;
a target quality element acquisition unit configured to acquire a target quality element of the workpiece; and
an output unit configured to output the machining element corresponding to the second non-control element and the target quality element by using the learning model.

6. The support device for a machine tool according to claim 5, wherein the output unit outputs corresponding machining control elements with a plurality of patterns, and outputs an order of the plurality of patterns based on a predetermined condition set in advance.

7. A machine tool system comprising:
a plurality of machine tools;
a server configured to communicate with the plurality of machine tools;
a plurality of edge computers provided in the plurality of machine tools, respectively, and configured to communicate with the server,
wherein the server comprises the learning model generation device for supporting a machine tool according to claim 1,
wherein the learning model generation device for supporting a machine tool generates the learning model based on the first non-control element, the machining control element and the actual quality element acquired from each of the plurality of machine tools,
wherein each of the plurality of edge computers comprises the support device for a machine tool, the support device for a machine tool comprising
a second non-control element acquisition unit configured to acquire a second non-control element, the second non-control element including at least one of specifications of the workpiece and specifications of the tool and being not a machining control element for a machine tool,
a target quality element acquisition unit configured to acquire a target quality element of the workpiece, and
an output unit configured to output the machining element corresponding to the second non-control element and the target quality element by using the learning model;
wherein the learning model generation unit of the learning model generation device for supporting a machine tool stores the generated learning model in the learning model storage unit of the support device for a machine tool.
